(19) United States
(12) Patent Application Publication
(10) Pub. No.: US 2013/0029340 A1
(43) Pub. Date: Jan. 31, 2013

(54) METHOD FOR DETECTING MORE THAN ONE TARGET IN A PCR-BASED APPROACH APPLYING AN UN-SPECIFIC DYE WHICH IS NOT INTERFERING WITH THE EMISSION OF FLUOROPHORE-LABELED PROBES

(71) Applicant: Steffen Mergemeier, Berlin (DE)

(72) Inventor: Steffen Mergemeier, Berlin (DE)

(21) Appl. No.: 13/522,253

(22) PCT Filed: Jan. 17, 2011
(86) PCT No.: PCT/EP11/00279

§ 371 Date: Sep. 25, 2012

(30) Foreign Application Priority Data
Jan. 15, 2010 (EP) 10075025.6

(51) Int. Cl. G01N 21/64

(52) U.S. Cl. 435/6.12

(57) ABSTRACT

The present invention relates to a method for detecting more than one target with sequence-specific probes and to distinguish these targets at the same time during melting point analysis.

### BACKGROUND

The present invention relates to a method for detecting more than one target with sequence-specific probes and to distinguish these targets at the same time during melting point analysis.

Real-time polymerase chain reaction, also called quantitative real time polymerase chain reaction (qRT-PCR) or kinetic polymerase chain reaction, is a laboratory technique based on the polymerase chain reaction, which is used to amplify and simultaneously quantify a targeted nucleic acid molecule. It therefore enables both detection and quantification of a specific sequence in a DNA sample. The method follows the general principle of polymerase chain reaction. Its key feature is that the amplified DNA is quantified as it accumulates in the reaction in real time after each amplification cycle. There are two common methods of quantification:
I. the use of fluorescent dyes that intercalate with double-stranded DNA, and
II. modified DNA oligonucleotide probes that fluoresce when hybridized with a complementary DNA.

Both methods have various disadvantages. For example double stranded DNA dyes such as SYBR Green will bind to all double stranded DNA PCR products, including nonspecific PCR products (such as “primer dimers”). This can interfere with or prevent accurate quantification of the intended target sequence.

Using fluorescent reporter probes is very expensive. This method uses a sequence-specific RNA or DNA-based probe to quantify only the DNA containing the probe sequence; therefore, use of the reporter probe significantly increases specificity, and allows quantification even in the presence of some non-specific DNA amplification. This potentially allows for multiplexing—assaying for several genes in the same reaction by using specific probes with different-colored labels, provided that all genes are amplified with similar efficiency. The major limitation of this method is the fact, that the number of different-colored probes is limited by the number of channels, which detect the emitted light (so called detection channels). Also the emitted light of some labeled probes is detected in more than one channel. Therefore most of the times not even all channels can be used as detection channels. So far the number of targets which can be amplified and distinguished is limited by the number of detection channels and the number of different probes. Another problem is that PCR machines from various manufacturer have different detection channels and no kits are available, which can be used with any PCR machine, resulting in a high prize for the kits.

Also disadvantageous is the fact that unspecific products cannot be distinguished from the products of interest. For example primer dimers remain undetected, which is a problem because they limit the sensitivity of the method.

It was an objective of the invention to provide a method which overcomes the problems known in the state of art and allow both the detection and the distinction of a large number of targets at once.
Surprisingly the invention solves the underlying problem by providing a method for amplifying and identifying at least one target in one reaction comprising the following steps:
   (a) providing a sample containing at least one target,
   (b) mixing at least one target with
      (i) at least two primers, whereby more than one target can be amplified,
      (ii) at least two sequence-specific probes, wherein the emitted light of at least two sequence-specific probes is detected but cannot be distinguished,
      (iii) an unspecific dye, wherein the emitted light of the unspecific dye is not detected in a detection channel which detects the emitted light of the sequence-specific probes in (ii),
      (iv) oligonucleotides,
      (v) a polymerase and optionally
      (vi) buffer, MgCl2, amplification control and/or water,
   (c) amplification of the target,
   (d) melting curve analysis, wherein the unspecific dye is used to distinguish the amplified targets during melting curve analysis.

The sample which contains at least one target is mixed with at least two primers, whereby more than one target can be amplified in one reaction. To this mix, at least two sequence-specific probes are added, wherein the emitted light of at least two sequence-specific probes is detected but cannot be distinguished. Additionally, an unspecific dye is added to the mix, wherein the emitted light of the unspecific dye is not detected in a detection channel which detects the emitted light of the sequence-specific probes. For the amplification of the targets further components such as oligonucleotides, a polymerase and optionally buffer, MgCl₂, amplification control and/or water are needed. After amplification of the target and incorporation of the unspecific dye, a melting curve analysis is carried out, wherein the unspecific dye is used to distinguish the amplified targets during melting curve analysis. Advantageously, unlike conventional methods, the method of the present invention uses an unspecific dye, which is added to the PCR reaction mix and incorporated into the amplified DNA, thereby allowing the discrimination of the amplified unknown samples in one step using a melting curve analysis.

The following terms are used to describe the invention:

The term “sample” is preferably used to describe a representative part or single item from a larger whole or group.

The term “target” especially defines the region or part of the sample which is to be amplified by the method of the invention. The primers are specifically designed to hybridize to the target region, which is then amplified by the DNA polymerase.

The term “unspecific dye” is preferably used to describe a dye, which interacts with DNA and binds unspecifically to it. The emitted light of the unspecific dye can be detected in a detection channel. An unspecific dye can be a saturated dye or an non saturated dye.

The melting curve analysis describes a method which is based on the melting point temperature, usually determined experimentally by subjecting the sample to a constitutive increase in temperature and continuously measuring the dissociation of the hybridization complex into single strands. The melting point temperature is defined by the composition of the double-stranded DNA, i.e. by the length, the nucleotide composition and complementary. By means of the melting point temperature of an amplified target it is possible to identify said target.

The term “polymerase” describes an enzyme used in the polymerase chain reaction. Such enzymes include the Taq polymerase, a thermostable DNA polymerase named after the thermophilic bacterium Thermus aquaticus. Other thermostable polymerases are e.g. the Pfu DNA polymerase, which has been isolated from the hyperthermophilic bacterium Pyrococcus furiosus and has a 3′-5′ exonuclease proofreading activity. Two DNA polymerases are mentioned exemplarily but do not represent limitations to the invention.

“Probes” are molecules capable of interacting with a target nucleic acid, typically in a sequence specific manner, for example through hybridization. The hybridization of nucleic acids is well understood in the art and discussed herein. Typically a probe can be made from any combination of nucleotides or nucleotide derivatives or analogs available in the art.

The term “oligonucleotide” describes a nucleic acid sequence, which is preferably single-stranded and has a length of less than 200, preferably less than 100 nucleotides. It is preferred that the oligonucleotides added are deoxyribonucleoside triphosphates dATP, dCTP, dGTP and UP. Synthetic deoxyribonucleoside triphosphates can be used as well. The deoxyribonucleoside triphosphates are added to the synthesis mixture in adequate amounts.

The term “primer” as used herein refers to an oligonucleotide, whether occurring naturally as in a purified restriction digest or produced synthetically, which is capable of acting as a point of initiation of synthesis when placed under conditions in which synthesis of a primer extension product which is complementary to a nucleic acid strand is induced, i.e., in the presence of nucleotides and an inducing agent such as DNA polymerase and at a suitable temperature and pH. The primer is preferably single stranded for maximum efficiency in amplification, but may alternatively be double stranded. If double stranded, the primer is first treated to separate its strands before being used to prepare extension products. Preferably, the primer is an oligodeoxyribonucleotide. The primer must be sufficiently long to prime the synthesis of extension products in the presence of the inducing agent. The exact lengths of the primers will depend on many factors, including temperature, source of primer and use of the method. For example, for diagnostics applications, depending on the complexity of the target sequence, the oligonucleotide primer typically contains 15-25 or more nucleotides, although it may contain fewer nucleotides. For other applications, the oligonucleotide primer is typically shorter, e.g., 7-15 nucleotides. Such short primer molecules generally require cooler temperatures to form sufficiently stable hybrid complexes with template. The person skilled in the art is capable of choosing suitable primers for a certain amplification.

The primers herein are selected to be “substantially” complementary to the different strands of each specific sequence to be amplified. This means that the primers must be sufficiently complementary to hybridize with their respective strands. Therefore, the primer sequence do not need to reflect the exact sequence of the template. For example, a non-complementary nucleotide fragment may be attached to the 5′ end of the primer, with the remainder of the primer sequence being complementary to the strand. Alternatively, non-complementary bases or longer sequences can be interspersed into the primer, provided that the primer sequence has sufficient complementarity with the sequence of the strand to be amplified to hybridize therewith and thereby form a template for synthesis of the extension product of the other primer.

The method of the invention allows the amplification of at least one target using a DNA polymerase and two primers, which guarantee the specific amplification of the chosen target. Additionally, two sequence-specific probes hybridize to the target region. The probes emit light, which is detected in the detection channels, but as the probes emit light with a similar emission spectrum, the emission can not be distinguished. The intercalating unspecific dye is incorporated into the DNA double-strand during amplification. The sequence-specific probes allow the quantification of the unknown target. But it is not possible to identify primer dimers. However, the incorporated unspecific dye is released during melting curve analysis and the emission can be detected in a detection channel which is not the same as the detection channel, detecting the emission of the sequence-specific probes. The melting curve analysis is used to further characterize the amplified targets and to distinguish the composition of different amplified targets.

Also preferred is the method, wherein the amplification is a real time PCR (qRT-PCR), as it allows the quantification of the amplified target in real-time. Polymerase Chain Reaction is abbreviated as “PCR”. The term “real-time PCR” is intended to mean any amplification technique which makes it possible to monitor the progress of an ongoing amplification reaction as it occurs (i.e. in real time). Data is therefore collected during the exponential phase of the PCR reaction, rather than at the end point as in conventional PCR. Measuring the kinetics of the reaction n the early phases of PCR provides distinct advantages over traditional PCR detection. In real-time PCR, reactions are characterized by the point in time during cycling when amplification of a target is first detected rather than the amount of target accumulated after a fixed number of cycles. The higher the starting copy number of the nucleic acid target, the sooner a significant increase in fluorescence is observed. Traditional PCR methods use separation methods, such as agarose gels, for detection of PCR amplification at the final phase of or end-point of the PCR reaction. For qRT-PCR no post-PCR processing of the unknown DNA sample is necessary as the quantification occurs in real-time during the reaction. Furthermore, an increase in reporter fluorescent signal is directly proportional to the number of amplicons generated. The qRT-PCR can be applied to applications such as viral quantification, quantification of gene expression, array verification, drug therapy efficacy, DNA damage measurement, quality control and assay validation, pathogen detection and genotyping.

In accordance with another aspect of the present invention, fluorescence monitoring is used to acquire product melting curves during the method by fluorescence monitoring with unspecific dyes and can further been used for melting curve analyse to gather information about the DNA. Plotting fluorescence as a function of temperature as the thermal cycler heats through the dissociation temperature of the product gives an amplified product melting curve. The shape and position of this DNA melting curve is a function of GC/AT ratio, length, and sequence, and can be used to differentiate amplification products separated by less than 2° C. in melting temperature. Additionally desired products can be distinguished from undesired products, including primer dimers. Analysis of melting curves can be used to extend the dynamic range of quantitative PCR and to differentiate different products in multiplex amplification.

It is understood that any method containing the aforementioned steps is a method of the invention, even if the sample does not comprise a target. There are various set ups where it is unknown whether a sample comprises a target or whether not. For example the method of the invention can be used to analyze a blood sample, whereby it is uncertain if the blood sample comprises a target, such as pathogen bacterial DNA. It is possible that no target can be amplified, because the sample did not contain any target of interest. However, these applications use also the method of the invention.

A preferred embodiment is a real time PCR for distinguishing and/or identifying at least one target, wherein at least two sequence-specific probes are used, wherein the emitted light of the sequence-specific probes is detected in the same detection channel of a PCR machine and wherein an unspecific dye is used to indentify and/or distinguish amplified targets during melting curve analysis. The real time PCR allows the quantification of a target sequence in real time without the need for post-PCR analysis. The sequence-specific probes hybridize to a specific DNA sequence and emit light. The emitted light is detected in the detection channel and correlates with the amount of amplified target. Both sequence-specific probes emit light in the same detection channel and are subsequently not discriminable. The unspecific dye however, which unspecifically interacts with the DNA emits light in a detection channel distinguishable from the detection channel of the two sequence-specific probes. Based on this, a subsequent employed melting curve analysis can be used to distinguish the amplified targets and to identify primer dimers. The qRT-PCR in combination with the melting curve analysis thereby provides a rapid and reliable analytic method which is a departure from the beaten track and is powerful diagnostic tool allowing the characterisation of diseases such as cancer and the proper identification of microbiological infections.

Another especially preferred embodiment is a real time PCR, wherein more than 2 sequence-specific probes are used, wherein the emitted light of at least two sequence-specific probes is detected in the same detection channel of a PCR machine. The preferred embodiment allows the use of two sequence-specific probes which preferably bind to two different target sequences. During amplification of the target sequence, the sequence-specific probes hybridize to their complementary sequences and allow the quantification of the amplification of the target sequence. The sequence-specific probes emit light in the same detection channel and cannot be distinguished. A subsequent employed melting curve analysis can be used to distinguish the amplified targets. With the use of the preferred embodiment, the amplification of two different targets is possible. The analysis of more than one target is important for the correct identification of pathogens such as bacteria or viruses, where the identification of the specific strain is essential for the appropriate treatment.

In another preferred embodiment the invention relates to a method, wherein the amplification is a multiplex PCR with at least two pairs of primer and wherein the amplified products are identified and distinguished in the melting curve analysis. The multiplex PCR is a variant of the standard PCR in which two or more loci are simultaneously amplified in the same reaction, by including more than one pair of primers in the reaction. It can be applied in many areas of DNA testing, including analysis of deletions, mutations and polymorphisms, or quantitative assays and reverse transcription PCR. Advantageously, multiplex PCR is capable of screening various microbial organisms simultaneously or identify different alleles of one organism. It provides a rapid and reliable analytic tool which can be adapted easily and is inexpensive.

Also preferred is the method, wherein the unspecific dye is an double strand DNA specific dye, preferably ethidium bromide and/or GelRed and/or Sytox Orange.

It was very surprising that ethidium bromide is suited to solve the underlying technical problem. Ethidium bromide does not interfere with the sequence specific probes. Therefore the detection of the sequence specific probes is not affected by ethidium bromide. Ethidium bromide is a cheap substance which is already available in most laboratories. Therefore no expansive substances have to be obtained.

The fluoresce of ethidium bromide intensifies 20 to 50-fold after binding to DNA. It was very surprising that the strong fluorescent signal of ethidium bromide does not interfere with the detection of the sequence specific probes. Ethidium bromide is an intercalating aromatic substance which interacts unspecifically with DNA. The emission of ethidium bromide is distinguishable from the emission of the sequence-specific probes, meaning that the emission is also detected in a different detection channel. It can be directly applied to the PCR reaction mix and is incorporated into the amplified target during amplification. But as it does emit light in a different detection channel, the quantification of the amplified target is not affected by ethidium bromide. However, it allows the analysis of the amplified targets in a subsequent employed melting curve analysis. During melting curve analysis ethidium bromide is released and the change of fluorescence is detected in a detection channel, which is not different from the detection channel detecting the sequence-specific probes. Using ethidium bromide in combination with sequence-specific probes thereby allow quantification of the amplified target by qRT-PCR and analysis of the composition of the target with melting point analysis. The detection of primer dimers is also possible.

Especially preferred is the method, wherein the unspecific dye is GelRed. It was very surprising that GelRed is suited to solve the underlying technical problem. GelRed is an ultra sensitive, extremely stable and environmentally safe fluorescent nucleic acid dye and therefore advantageous.

Another advantage of GelRed is the fact that it is noncytotoxic, nonmutagenic and nonhazardous. Therefore GelRed can be safely disposed of down the drain or in regular trash.

GelRed and ethidium bromid and also Sytox Orange have almost the same spectra, so they can be replaced without changing the method. Therefore the emission of GelRed is distinguishable from the emission of the sequence-spcific probes as well, meaning that the emission is also detected in a different detection channel. It can be directly applied to the PCR reaction mix and is incorporated into the amplified target during amplification. But as it does emit light in a different detection channel, the quantification of the amplified target is not affected by GelRed. However, it allows the analysis of the amplified targets in a subsequent employed melting curve analysis. During melting curve analysis GelRed and the change of fluorescence is detected in a detection channel, which is different from the detection channel detecting the sequence-specific probes. Using GelRed in combination with sequence-specific probes thereby allow quantification of the amplified target by qRT-PCR and analysis of the composition of the target with melting point analysis. The detection of primer dimers is also possible.

Sytox Orange is a very sensitive DNA binding dye. Already a very low concentration of Sytox Orange creates a fluorescence signal when bound to DNA. It was very surprising that the strong fluorescent signal of Sytox Orange does not interfere with the detection of the sequence specific probes. The emission of Sytox Orange is distinguishable from the emission of the sequence-specific probes, meaning that the emission is also detected in a different detection channel. It can be directly applied to the PCR reaction mix and is incorporated into the amplified target during amplification. But as it does emit light in a different detection channel, the quantification of the amplified target is not affected by Sytox Orange. However, it allows the analysis of the amplified targets in a subsequent employed melting curve analysis. During melting curve analysis Sytox Orange is released and the change of fluorescence is detected in a detection channel, which is different from the detection channel detecting the sequence-specific probes. Using Sytox Orange in combination with sequence-specific probes thereby allow quantification of the amplified target by qRT-PCR and analysis of the composition of the target with melting point analysis. The detection of primer dimers is also possible.

In an also preferred embodiment a very low concentration of the unspecific dye is used. By using a low concentration, the emitted light of the unspecific dye can not be detected in any detection channel, but the melting curve analysis can still be performed. Advantageously this embodiment enables the use of a sequence specific probe which emits light in the same detection channel as for example GelRed or Sytox Orange. Due to the very low concentration, the unspecific dye is not detectable in this channel and therefore does not interfere with the sequence specific probes.

Any source of nucleic acid, in purified or nonpurified form, can be utilized as the starting nucleic acid or acids, provided it contains or is suspected of containing the specific nucleic acid sequence desired. Thus, the process may employ, for example, DNA or RNA, including messenger RNA, which DNA or RNA may be single stranded or double stranded. In addition, a DNA-RNA hybrid which contains one strand of each may be utilized. A mixture of any of these nucleic acids may also be employed, or the nucleic acid produced from a previous amplification reaction herein using the same or different primers may be so utilized. The specific nucleic acid sequence to be amplified may be only a fraction of a larger molecule or can be present initially as a discrete molecule, so that the specific sequence constitutes the entire nucleic acid. It is not necessary that the sequence to be amplified be present initially in a pure form; it may be a minor fraction of a complex mixture, such as a portion of the beta-globin gene contained in whole human DNA or a portion of nucleic acid sequence due to a particular microorganism which organism might constitute only a very minor fraction of a particular biological sample. The starting nucleic acid may contain more than one desired specific nucleic acid sequence which may be the same or different. Therefore, the present process is useful not only for producing large amounts of one specific nucleic acid sequence, but also for amplifying simultaneously more than one different specific nucleic acid sequence located on the same or different nucleic acid molecules.

Also preferred is the method wherein the sample is selected from the group comprising blood samples, urine samples, semen samples, lymphatic fluid samples, cerebrospinal fluid samples, amniotic fluid samples, biopsy samples, plant samples, needle aspiration biopsy samples, cancer samples, tumour samples, tissue samples, cell samples, cell lysate samples, crude cell lysate samples, forensic samples, archeological samples, infection samples, nosocomial infection samples, environmental samples, soil samples, water samples, plant leaf samples, pollen samples, seed samples, food samples or combination thereof. It was surprising that the preferred method allows the analysis of such a variety of samples without the need for modifications. Especially in the diagnosis of microbiological infections, a rapid and reliable detection method is urgently needed, as pathogens such as bacteria and viruses adapt quickly and the identification of a specific strain is needed for the appropriate treatment. The preferred method provides an inexpensive and powerful tool which can be used by any laboratory facility and satisfies a long-felt need or want.

Also preferred is the method, wherein the sequence-specific probe is coupled to a fluorophore. The probe anneals to a specific sequence of template between the forward and reverse primers. The probe sits in the path of the enzyme as it starts to copy DNA or cDNA. When the enzyme reaches the annealed probe the 5′ exo nuclease activity of the enzyme cleaves the probe and the fluorescent emission of the reporter increases and allows the quantification of the unknown sample. As the unspecific dye has been incorporated into the amplified sample but does not interfere with the detection of the detected fluorophore, the sample can be further characterized in a melting curve analysis. The preferred method of the invention enables the person skilled in the art to use a highly-efficient quantification method such as PCR, preferably qRT-PCR or multiplex PCR and further distinguish the samples or identify primer-dimer using melting curve analysis without the need of additional analytic steps.

The terms “fluorescent label” or “fluorophore” refers to compounds with a fluorescent emission maximum between about 400 and 900 nm. These compounds include, with their emission maxima in nm in brackets, Cy2 (506), GFP (Red Shifted) (507), YO-PRO-1 (509), YOYO™-1 (509), Calcein (517), FITC (518), FluorX (519), Alexa (520), Rhodamine 110 (520), 5-FAM (522), Oregon Green 500 (522), Oregon Green 488 (524), RiboGreen (525), Rhodamine Green (527), Rhodamine 123 (529), Magnesium Green (531), Calcium Green (533), TO-PRO.-1 (533), TOTO-1 (533), JOE (548), BODIPY 530/550 (550), Dil (565), BODIPY (568), BODIPY 558/568 (568), BODIPY 564/570 (570), Cy3 (570), Alexa 546 (570), TRITC (572), Magnesium Orange (575), Phycoerythrin R&B (575), Rhodamine Phalloidin (575), Calcium Orange (576), Pyronin Y (580), Rhodamine B (580), TAMRA (582), Rhodamine Red (590), Cy3.5 (596), ROX (608), Calcium Crimson (615), Alexa 594 (615), Texas Red (615), Nile Red (628), YO-PRO-3 (631), YOYO-3 (631), R-phycocyanin (642), C-Phycocyanin (648), TO-PRO-3 (660), TOTO-3 (660), DiD DilC(5) (665), Cy5 (670), Thiadicarbocyanine (671), Cy5.5 (694).

Also preferred is the method, wherein the sequence-specific probe is selected from the group comprising TaqMan-probes, molecular beacons, scorpions, biprobes and hybridization probes, which all generate a fluorescent signal. Real-time PCR systems improved by the introduction of fluorogenic-labeled probes (commonly termed TaqMan-probes) that use the 5′exonuclease activity of the Taq DNA polymerase and represent the latest development in quantitative PCR methods. By utilizing an internal probe in addition to standard PCR amplification primers, TaqMan chemistry combines the amplification power of PCR with the specificity and verification of hybridization techniques. The use of these probes enabled the development of a real-time method for detecting only specific amplification products allowing the identification of an unknown sample. The addition of an unspecific dye to the unknown sample and the sequence-specific probes does not interfere with the detection channel of the sequence-specific fluorophore. The incorporation of the unspecific dye into the amplified sample allows the identification of primer-dimers and the use of the amplified sample for further melting curve analysis without the need for additional analytic equipment. The preferred method uses a sequence-specific probe labeled with a fluorophore which allows the efficient and accurate quantification of the amplified target.

Further preferred is the method, wherein the unspecific dye is released during the melting curve analysis. Melting curve analysis is a known method to the person skilled in the art and is a well-established method for characterizing amplicons. The unspecific dye is incorporated during DNA or cDNA amplification. During the temperature-dependent dissociation of two DNA-strands, the unspecific dye is released and can be detected in a detection channel which is not the detection channel used by the sequence-specific fluorophore. The release of unspecific dye directly correlates with the stability and composition of the DNA and allows to scan for sequence variations in an unknown sample. Single-base changes in the target amplicons are detected by their altered melting-properties which is monitored through the release of fluorescent double-stranded DNA binding dye. These altered melting properties give rise to changes in the shape of the melting curve compared to a known sample and allow the characterization of the unknown sample. The preferred method of the invention allows the characterisation of a target by analysing the release of the unspecific dye during melting curve analysis. As the unspecific dye emits light which is distinguishable from the light emitted by the sequence-specific probes, the release of the fluorophore can be used to analyse the composition of the target and identify primer dimers.

Preferably the method of the invention can be combined with reverse transcription to quantify messenger RNA (mRNA) in cells or tissues. Reverse transcription describes the process where RNA is reverse transcribed into its DNA complement using the enzyme reverse transcriptase. The resulting cDNA (complementary DNA) is amplified using traditional PCR (RT-PCR). The exponential amplification via RT-PCR provides for a highly sensitive technique, where a low copy number of mRNA molecules are detectable. Compared to the two other commonly used techniques for quantifying mRNA levels, Northern blot analysis and Rnase protection assay, RT.PCR can be used to quantify mRNA levels from much smaller samples and provides a highly efficient and inexpensive method.

Another preferred method is to differentiate the amplified targets and/or unspecific products, preferred primer dimers. The detection of the formation of primer dimers is important because they affect the sensitivity of a PCR. Therefore the interpretation of results is more accurate, if primer dimers can be detected. The preferred method allows the efficient detection of primer dimers and the differentiation of amplified targets.

Also preferred is the use of the method for the detection of bacteria, viruses, fungi, parasites, cancer, mutations and/or animal products. The preferred method allows the detection of mutations and single-nucleotide polymorphisms and can be used as rapid screening method to reduce the number of steps required to detect new variants of bacteria, viruses, fungi and parasites and additionally provides an efficient method to characterize genetic abnormalities such as cancer. New strains of bacteria, viruses, fungi and parasites are arising constantly and differentiation and identification of the strains is important to allow the characterisation of microbiological infections and the appropriate treatment. Also, the analysis of animal products such as tissue, bones and bodily fluids is preferred. The preferred method allows for example the detection of animal products in an unwanted place. It therefore satisfies a long-felt need as it enables the rapid, efficient and inexpensive detection method for bacteria, viruses, fungi, parasites, cancer, mutations and/or animal products.

Further preferred is the use of the method in the diagnosis of diseases, GMO-screening, detection of pathogens or food quality testing. Many pathogens, such as bacteria viruses, fungi or parasites, need to be identified quickly as the time frame in which treatment choices must be made is short. The preferred method of the invention advantageously provides a rapid, sensitive, reliable and inexpensive detection method. It is therefore suitable for use in clinical laboratories as well as research facilities. Especially the diagnosis of disease and detections of pathogens need to performed as quickly as possible. The preferred method of the invention also enables the identification of GMO (genetic modified organisms). GMO contain specific and well-defined nucleic acid sequences and are well suited for detection by PCR. However, as mutations occur rapidly, the method of the invention provides an additional method for detecting and identifying mutated GMO. The preferred method can also be applied to food quality testing as it allows the rapid and efficient identification of food contaminations, which are unwanted elements, such as Salmonella strains, present in food. The preferred method enables a rapid detection and investigation of food contaminations and provides an inexpensive procedure to avoid rapid outbreaks of food poisoning.

The invention also relates to a Kit comprising an unspecific dye, preferred ethidium bromide and/or GelRed and/or Sytox Orange, at least two sequence-specific probes, oligonucleotides, a polymerase and optionally buffer, MgCl2, an amplification control and/or water. Two sequence-specific probes which bind to their complementary DNA or cDNA sequences and are coupled with a fluorophore. Additionally, an unspecific dye, preferably ethidium bromide and/or GelRed and/or Sytox Orange is added. Buffer and MgCl2 are optionally needed by the DNA polymerase and catalyze the enzymatic reaction. The oligonucleotides are needed by the polymerase to generate the complementary DNA strand. The unspecific dye is incorporated into the amplified double-stranded DNA but does not emit light in the same detection channel as the fluorophores coupled to the sequence-specific probes. The emission of the latter is not detected in the same detection channel. The Kit uses at least two sequence-specific probes in combination with an unspecific dye, preferably ethidium bromide and/or GelRed and/or Sytox Orange, thereby allowing the detection of the amplified DNA and furthermore the identification of the sample using the unspecific dye. The Kit can be used in combination with a melting curve analysis, in which the unspecific dye is released and measured to analyse the composition of the amplified target. The Kit is therefore a departure from the beaten track as it contains sequence-specific probes and an unspecific dye which both allow the rapid an reliable identification and characterisation of a target.

A preferred embodiment of the Kit additionally comprises at least two primers. The two primers bind to an unknown DNA sample and promote the elongation by the polymerase. The unspecific dye, preferably ethidium bromide and/or GelRed and/or Sytox Orange in incorporated into the growing double-stranded DNA, while the amplification of the unknown sample is quantified in real-time by measuring the fluorescence of at least two sequence-specific probes, which is detected in the detection channel. The unspecific dye does not emit light in the same detection channel than the sequence-specific probes. The preferred embodiment of the Kit allows the quantification of an unknown DNA or cDNA sample and also allows to further characterize the unknown sample. The latter is carried out by analyzing the release of the in the double-stranded DNA incorporated unspecific dye during melting curve analysis. The release directly correlates with the composition and stability of the double-stranded DNA and allows the discrimination between various samples, at least two. The preferred embodiment of the Kit thereby provides a one step procedure which is reliable, rapid, efficient and inexpensive and combines the quantification of a PCR-based method, preferably qRT-PCR or multiplex PCR with the analytic power of the melting curve analysis.

The teachings of the present invention are characterised by the following features:
departure from the beaten track
a new perception of the problem
satisfaction of a long-felt need or want
hitherto all efforts of experts were in vain
the simplicity of the solution, which proves inventive action, especially since it replaces a more complex doctrine
the development of scientific technology followed another direction
the achievement forwards the development misconceptions among experts about the solution of the according problem (prejudice)
technical progress, such as: improvement, increased performance, price-reduction, saving of time, material, work steps, costs or resources that are difficult to obtain, improved reliability, remedy of defects, improved quality, no maintenance, increased efficiency, better yield, augmentation of technical possibilities, provision of another product, opening of a second way, opening of a new field, first solution for a task, spare product, alternatives, possibility of rationalisation, automation or miniaturisation or enrichment of the pharmaceutical fund
special choice; since a certain possibility, the result of which was unforeseeable, was chosen among a great number of possibilities, it is a patentable lucky choice
error in citations
young field of technology
combined invention; a combination of a number of known elements, with a surprising effect
licensing
praise of experts and
commercial success

Said advantages are shown especially in the preferential embodiments of the invention.

Preferred embodiments of the present invention are described by way of examples in more detail below referring to the following figures:

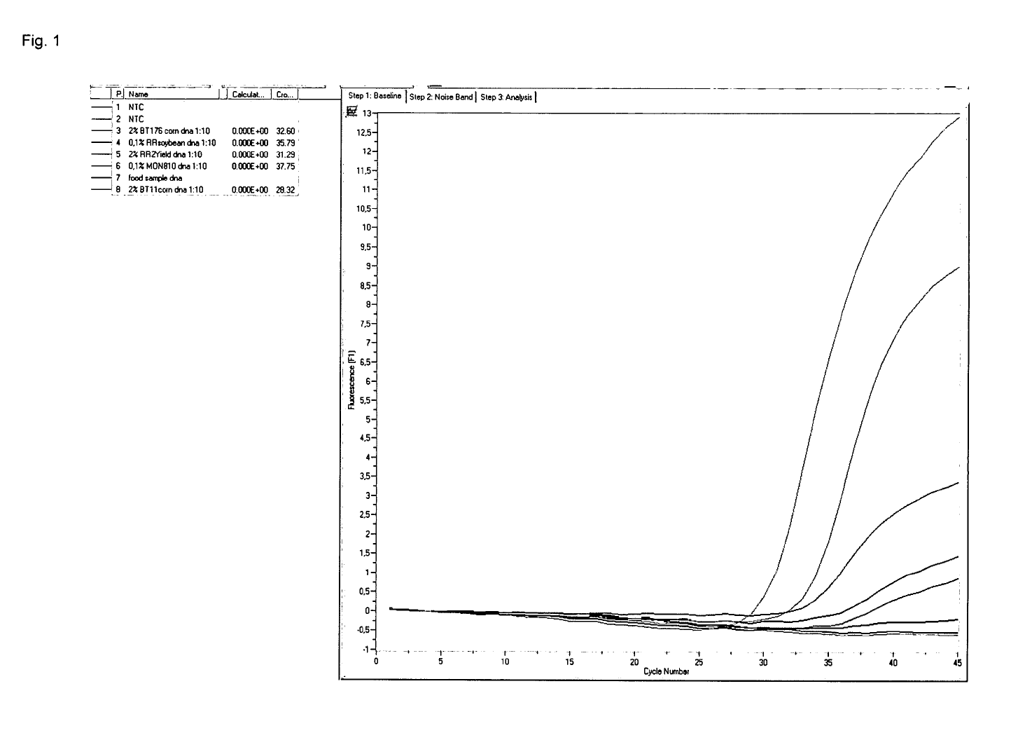

FIG. 1 F1 detection channel of a LightCycler 1.5 instrument

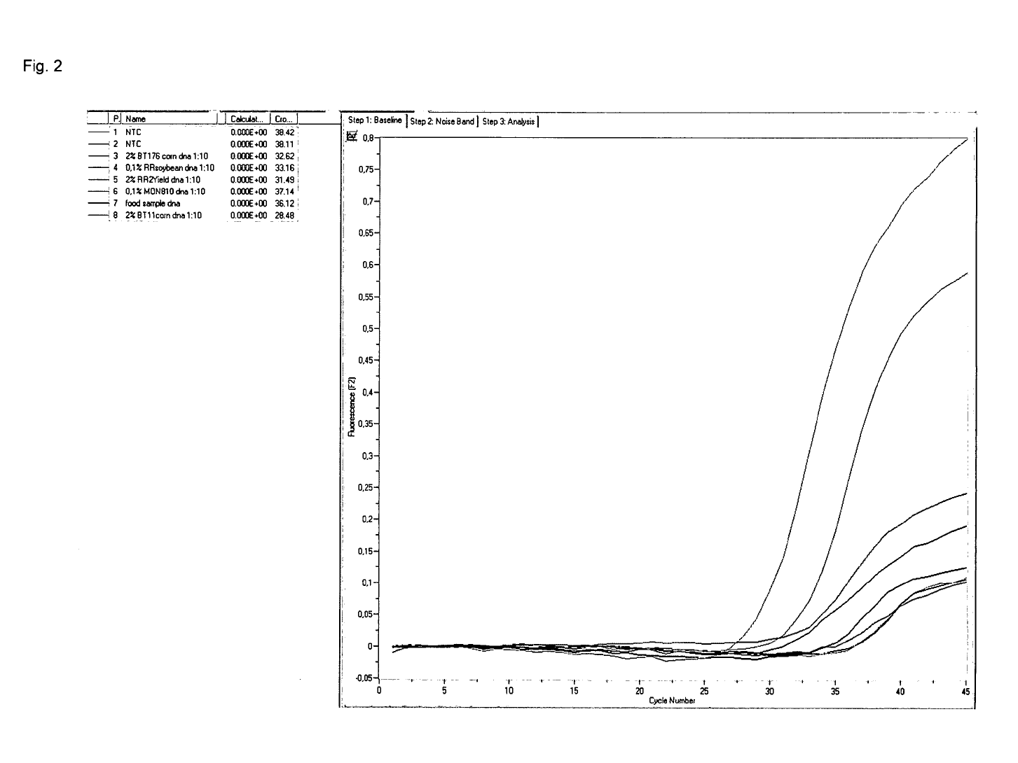

FIG. 2 F2 detection channel of the LightCycler 1.5 instrument

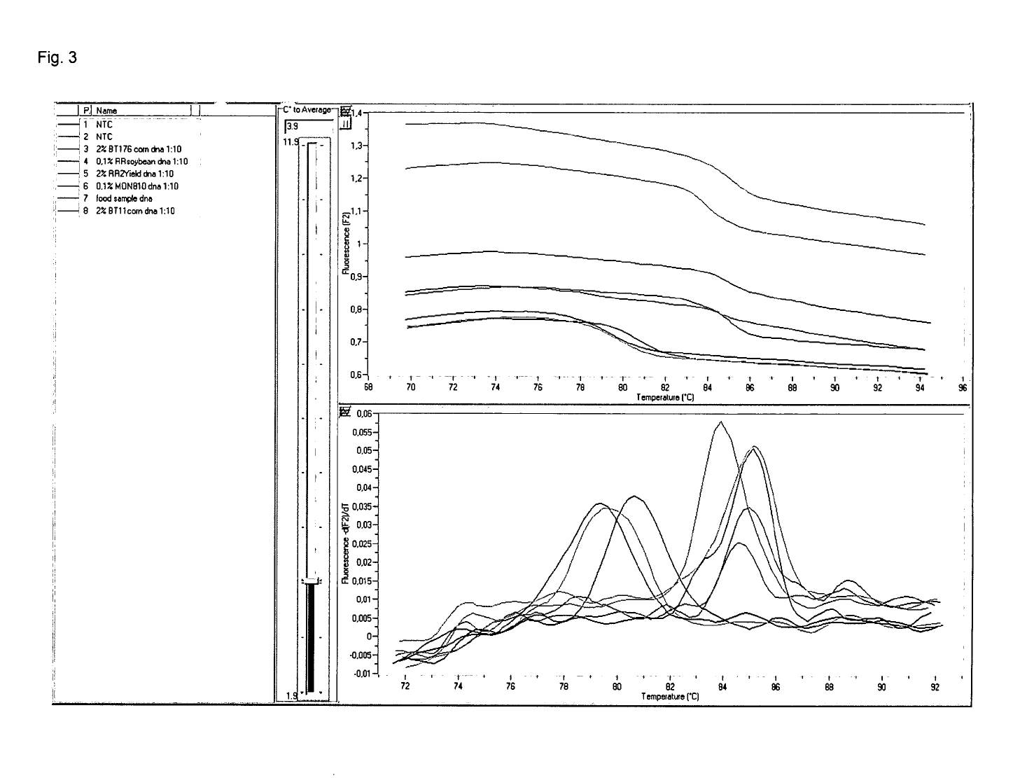

FIG. 3 A melting curve analysis in the F2 detection channel of the LightCycler 1.5 instrument

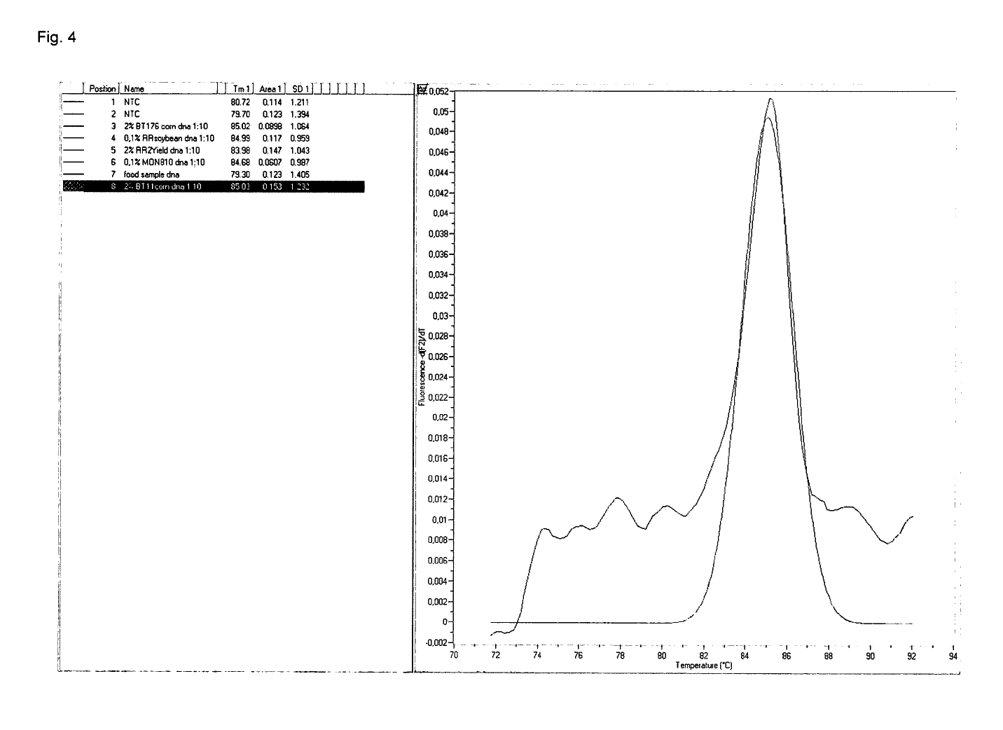

FIG. 4 Melting curve analysis in the F2 detection channel of the LightCycler 1.5 instrument in another interpretation

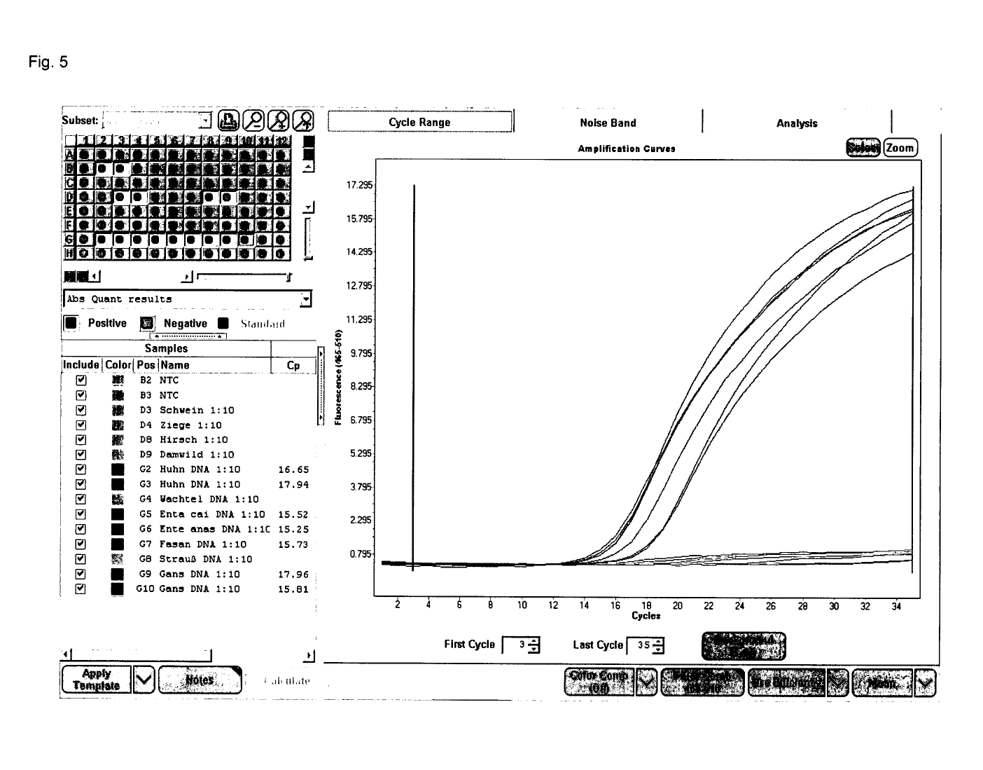

FIG. 5 The 465-510 detection channel of a LightCycler 480 instrument

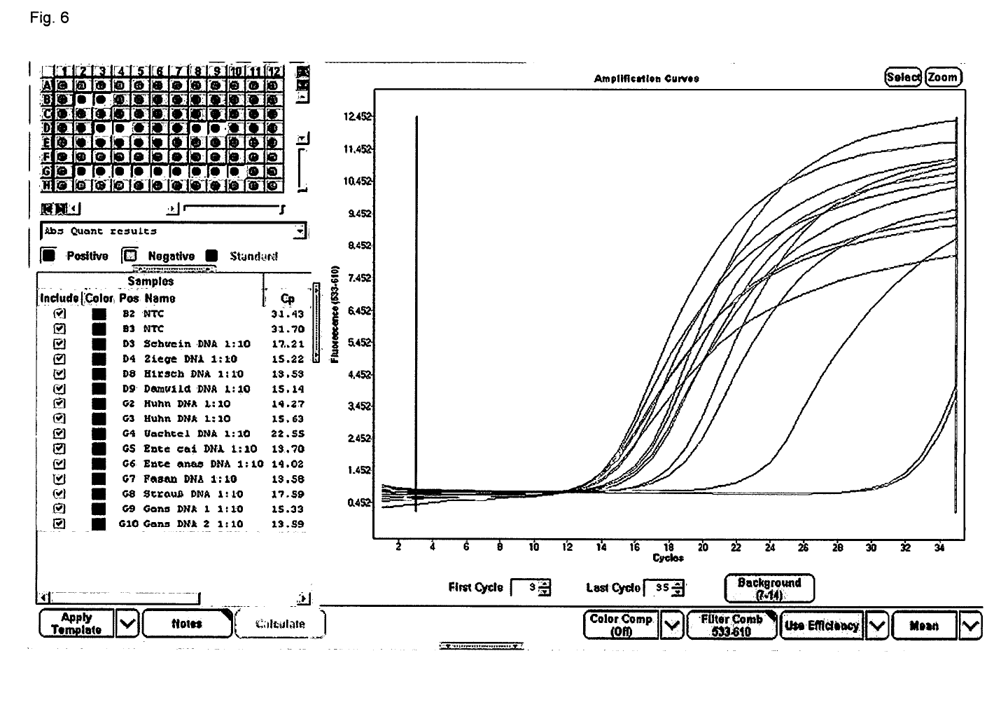

FIG. 6 The 530-610 detection channel of the LightCycler 480 instrument

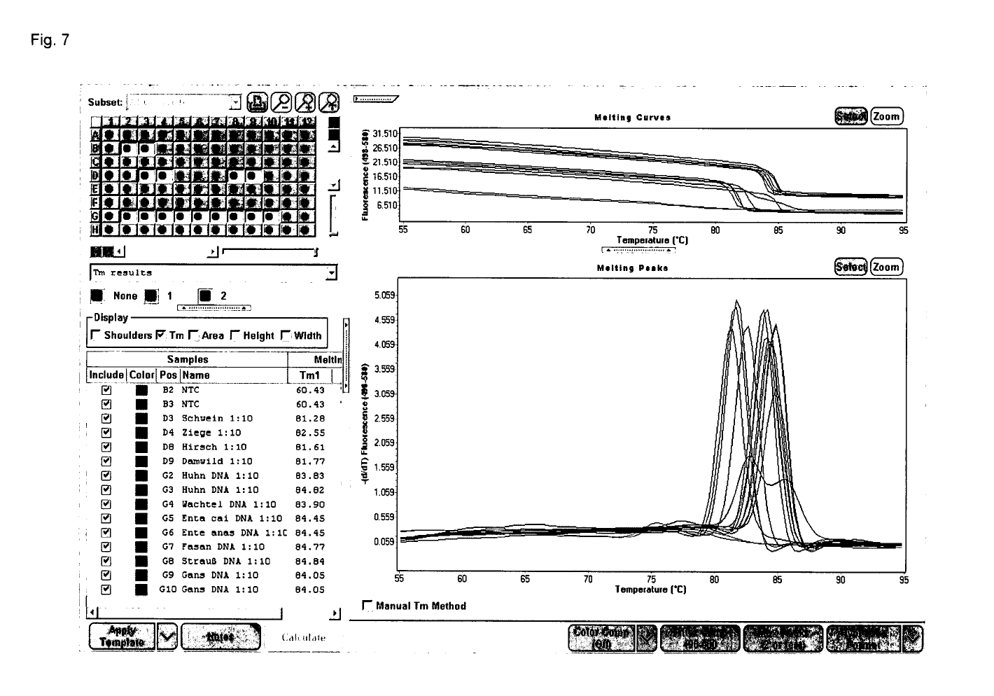

FIG. 7 The melting curve analysis in the 530-610 detection channel of the LightCycler 480 instrument

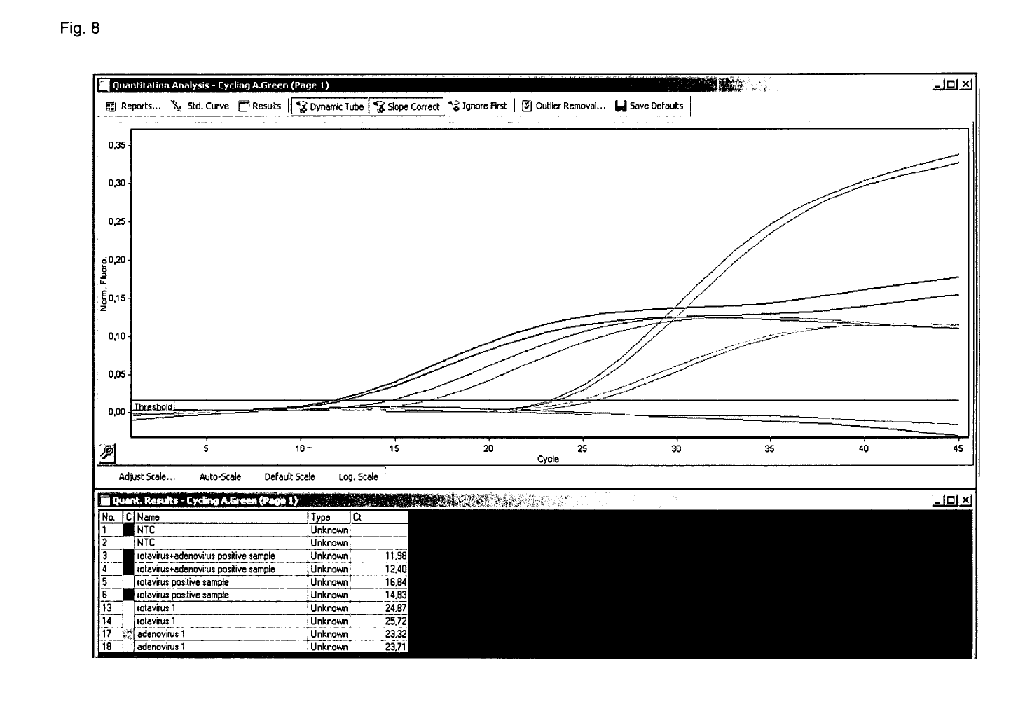

FIG. 8 The A.Green detection channel of a Rotorgene Q instrument

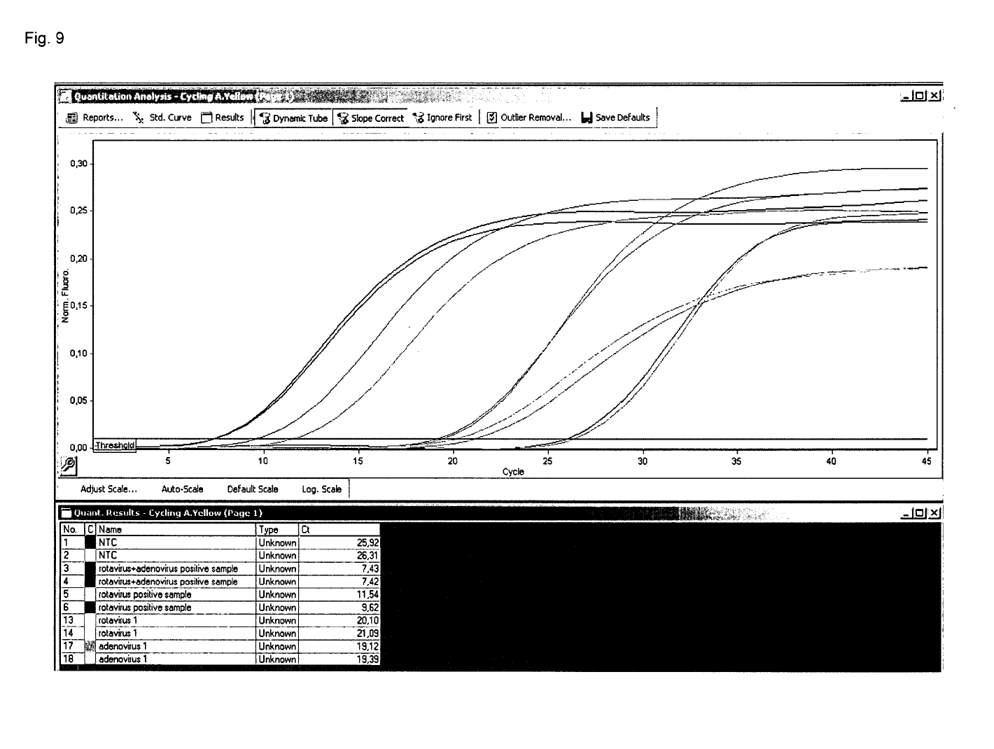

FIG. 9 The yellow detection channel of the Rotorgene Q instrument

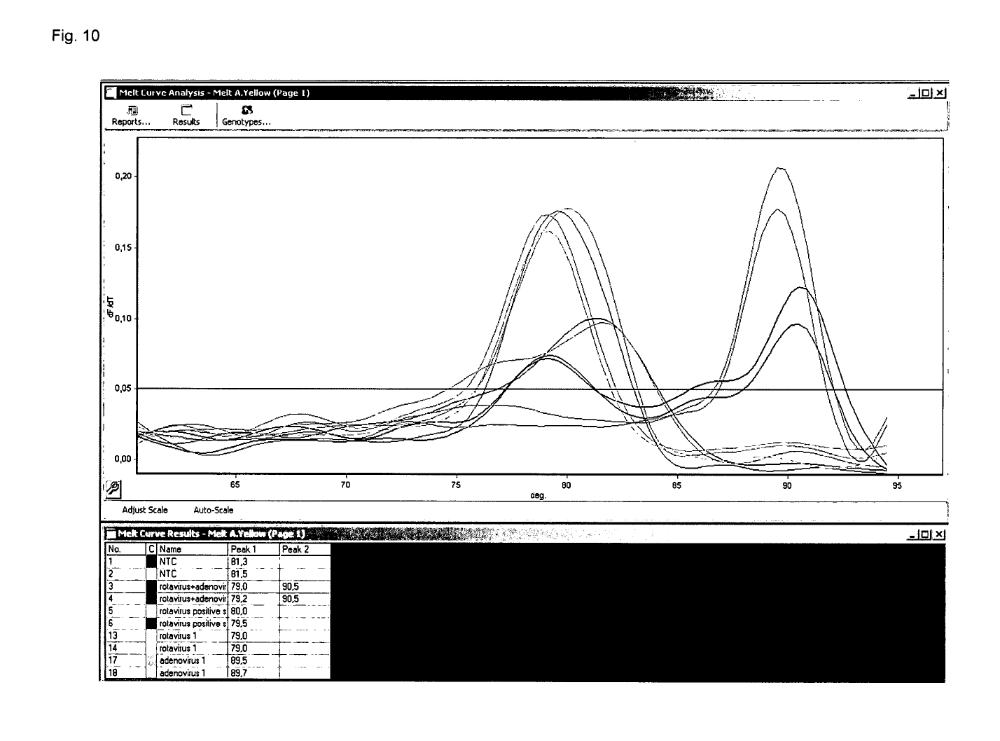

FIG. 10 The melting curve analysis in the Yellow detection channel of the Rotorgene Q instrument

### EXAMPLES

### Example 1

The primer and the probes for a genetically modified organism (GMO) screening system consisting of 35S promotor and FMV promotor are shown in Table 1.

TABLE 1

| Target and | | |
|---|---|---|
| oligo | SEQ ID NR. | Sequence |
| Primer | SEQ ID NR. 1 | ATGGACCCCCACCCAC |
| 35S | | |
| Promotor | | |
| forward | | |
| Primer | SEQ ID NR. 2 | AGATATCACATCAATCCACTTGC |
| 35S | | |
| Promotor | | |
| reverse | | |
| Probe | SEQ ID NR. 3 | FAM-GAAGACGTTCCAACCACGTC- |
| 35S | | BHQ1 |
| Promotor | | |
| Primer | SEQ ID NR. 4 | AAGACATCCACCGAAGACTTAAAGTT |
| FMV | | |
| Promotor | | |
| forward | | |
| Primer | SEQ ID NR. 5 | TCGTGCACCATTCCTTTTTTGTC |
| FMV | | |
| Promotor | | |
| reverse | | |
| Probe | SEQ ID NR. 6 | FAM-TGGTCCCCACAAGCCAGCT- |
| FMV | | BHQ1 |
| Promotor | | |

The following concentrations and volumes of components were used in the real-time PCR (see Table 2).

TABLE 2

| | Volume |
|---|---|
| Component | in μl |
| Water | 5.4 |
| 10 × PCR buffer | 2 |
| Deoxyribonucleotide triphosphates mixture, | 2 |
| concentration: 2.5 mM | |
| Bovine serum albumin solution | 1 |
| MgCl2, concentration: 25 mM | 4 |
| Primers (forward/reverse), concentration 5 pmol/μl | 1 |
| Probes, concentration: 5 pmol/μl | 0.6 |
| GelRed 1:2500 | 0.3 |
| hot-start TAQ-Polymerase, concentration: 10 U/μl | 0.1 |
| Total Volume master mix | 20 |
| DNA sample/extract | 5 |
| Total Volume | 25 |

A LightCycler 1.5 was used for the experiment with the following PCR cycle conditions (see Table 3).

TABLE 3

| | | |
|---|---|---|
| Initial Denaturation | | 1 min/95° C. |
| 45 Cycles | Denaturation | 10 s/95° C. |
| | Annealing/Elongation | 15 s/60° C. |
| TM analysis | | 60-95° C. |
| Cooling | | 15 s/40° C. |

FIG. 1 shows the F1 detection channel of the instrument. For all GMO positive samples is a positive signal measured. However it is not possible to distinguish between a 35S promotor positive sample or a FMV promotor positive sample. It is also not possible to interpret negative results regarding to the sensitivity of the PCR reaction.

FIG. 2 shows the F2 detection channel of the instrument. The signal of the GelRed dye is measured in the channel. For all samples is a positive signal observable. Additionally to the GMO positive samples is the formation of primer dimers in GMO negative samples observable. So it is possible to estimate the performance of the PCR system in negative samples.

FIG. 3 shows the melting curve analysis in the F2 detection channel of the LightCycler 1.5 instrument. There is the signal of the GelRed dye measured. For all samples is a positive signal observable. It is clear difference observable between the formation of primer dimers in the negative sample an the NTCs (no template control) and GMO positive samples. Additionally it is possible to distinguish between the only FMV promotor sample 5 (RR2 Yield DNA) and the 35S promotor positive samples 3, 4, 6 and 8.

FIG. 4 shows the melting curve analysis in the F2 detection channel of the LightCycler 1.5 instrument in another interpretation. The TM values of the samples are shown. The primer dimers have a TM value of approximately 80° C., the FMV positive sample of 83.98° C. and the 35S positive samples between 84.68° C. and 85.04° C. So it is possible to distinguish between the 35S and FMV promotor without using different detection channels for the probes.

The usage of sequence specific probes and a double strand specific dye gives additional information about every investigated sample.

### Example 2

The primer and the probes for a poultry screening system are shown in Table 4. The primer set is able to amplify all animal species usually utilised in the farm industry. The probe is able to detect goose, duck, pheasant and chicken.

TABLE 4

| Target | | |
|---|---|---|
| and | | |
| oligo | SEQ ID NR. | Sequence |
| Primer | SEQ ID NR. 7 | CACGAAGCAGGATCTAATAACCC |
| animal | | |
| all | | |
| forward | | |
| Primer | SEQ ID NR. 8 | GGGGTAGTTGTCTGGGTC |
| animal | | |
| all | | |
| reverse | | |
| Probe | SEQ ID NR. 9 | FAM-TAGCCCTATTCTCACCTAACCT- |
| farm | | BHQ1 |
| poultry | | |

The following concentrations and volumes of components were used in the real-time PCR (see Table 5):

TABLE 5

| | Volume |
|---|---|
| Component | in μl |
| Water | 7 |
| 10 × PCR buffer | 2 |
| Deoxyribonucleotide triphosphates mixture, | 2 |
| concentration: 2.5 mM | |
| Bovine serum albumin solution | 1 |
| MgCl2, concentration: 25 mM | 4 |
| Primers (forward/reverse), concentration 5 pmol/μl | 1.5 |
| Probes, concentration: 5 pmol/μl | 0.6 |
| Sytox Orange 1:400 | 0.3 |
| hot-start TAQ-Polymerase, concentration: 10 U/μl | 0.1 |
| Total Volume master mix | 20 |
| DNA sample/extract | 5 |
| Total Volume | 25 |

A LightCycler 480 was used for the experiment with the following PCR cycle conditions (see Table 6):

TABLE 6

| | | |
|---|---|---|
| Initial Denaturation | | 1 min/95° C. |
| 45 Cycles | Denaturation | 10 s/95° C. |
| | Annealing/Elongation | 15 s/55° C. |
| TM analysis | | 55-95° C. |
| Cooling | | 10 s/40° C. |

In FIG. 5 the 465-510 detection channel of a LC480 instrument is shown. For all poultry positive samples is a positive signal measured. However it is not possible to get an information about the correct DNA extraction for the negative samples. It is also not possible to interpret negative results regarding to the sensitivity of the PCR reaction.

The FIG. 6 shows the 530-610 detection channel of the instrument. There is the signal of the Sytox Orange dye measured. For all samples is a positive signal observable. The cycle threshold for all animal samples is between 13 and 18 with the exception of sample G4 with 22.55. It is possible that the DNA extraction of the sample G4 was not correct. A replicate of this sample is recommended. Without using a probe and the double strand specific dye is this information not reachable. The cycle threshold for the NTCs (no template control) is higher than 31 indicating a sensitive and correct PCR amplification.

FIG. 7 depicts the melting curve analysis in the 530-610 detection channel of the LightCycler 480 instrument. There is the signal of the Sytox Orange dye measured. For all samples is a TM curve observable. It is clear difference between the TM curve of the primer dimer formation in the NTCs (no template controls) and the positive samples. Additionally it is possible to distinguish between the poultry samples (G2-G10) and the samples for other animals (D3-D9) and the NTCs (no template controls). The TM value for the other investigated animals are between 81.23 for pork (D3) and 82.53 for goat (D4). The TM values for poultry are between 83.77 (G2 chicken) and 84.81 (G8 ostrich).

In case of a broad range PCR amplification system with specific probes for the detection of a minority of the amplified targets is the additional usage of a double strand specific dye especially advantageous. It is possible to check the correct DNA amplification and get additional information about samples not containing the target for the specific probe.

### Example 3

The primer and the probes for an adenovirus and a rotavirus screening system are shown in Table 7.

TABLE 7

| Target and | SEQ ID | |
|---|---|---|
| oligo | NR | Sequence |
| Primer | SEQ ID | CCAGTGGTCTTACATGCACATC |
| adenovirus | NR. 10 | |
| forward | | |
| Primer | SEQ ID | ACGGTGGGGTTTCTAAACTT |
| adenovirus | NR. 11 | |
| reverse | | |
| Probe | SEQ ID | FAM-TCTGGTGCAGTTTGCCCG- |
| adenovirus | NR. 12 | BHQ1 |
| Primer | SEQ ID | ACCATCTACACATGACCCTC |
| rotavirus | NR. 13 | |
| forward | | |
| Primer | SEQ ID | GGTCACATAACGCCCC |
| rotavirus | NR. 14 | |
| reverse | | |
| Probe | SEQ ID | FAM- |
| rotavirus | NR. 15 | CACAATAGTTAAAAGCTAACACTGT- |
| | | BHQ1 |

The following concentrations and volumes of components were used in the real-time PCR (see Table 8):

TABLE 8

| | Volume |
|---|---|
| Component | in μl |
| Water | 1.4 |
| Reaction Mix 2X Invitrogen | 12.5 |
| Bovine serum albumin solution | 1 |
| Primers (forward/reverse), concentration 10 pmol/μl | 0.75 |
| Probes, concentration: 5 pmol/μl | 0.6 |
| Sytox orange 1:400 | 0.3 |
| SSIII-Mix | 0.5 |
| hot-start TAQ-Polymerase, concentration: 10 U/μl | 0.1 |
| Total Volume master mix | 20 |
| DNA/RNA sample/extract | 5 |
| Total Volume | 25 |

A Rotorgene Q was used for the experiment with the following PCR cycle conditions (see Table 9).

TABLE 9

| | | |
|---|---|---|
| RT-reaction | | 10 min/58° C. |
| Initial Denaturation | | 1 min/95° C. |
| 45 Cycles | Denaturation | 10 s/95° C. |
| | Annealing/Elongation | 15 s/55° C. |
| TM analysis | | 60-95° C. |
| Cooling | | 10 s/40° C. |

The FIG. 8 shows the A.Green detection channel of the instrument. For all rotavirus and adenovirus positive samples is a positive signal measured. However it is not possible to distinguish between a rotavirus and a adenovirus and a double positive sample.

FIG. 9 shows the yellow detection channel of the instrument. There is the signal of the Sytox Orange dye measured. For all samples is a positive signal observable. The cycle threshold is proportional to the cycle threshold of the positive samples in the Green detection channel. Additionally is a positive signal for the NTCs (no template controls) observable. The cycle threshold for the NTCs is approximately 26. In reverse transcription real time PCR methods is the formation of primer dimers favoured because of the long reverse transcription time at a relatively low temperatures. Increased primer dimer formation reduce the sensitivity of the detection. With the target specific probe and the double strand specific dye it is possible to control the sensitivity of the detection reaction.

FIG. 10 depicts the melting curve analysis in the Yellow detection channel of the Rotorgene Q instrument. There is the signal of the Sytox Orange dye measured. For all samples is a TM curve observable. The rotavirus TM value is approximately 79° C. and the adenovirus TM value is approximately 90° C. The samples 3 and 4 have a TM value at 79° C. and a TM value at 90° C. The TM analysis demonstrate that this sample contains nucleic acid of the adenovirus and of the rotavirus. The samples 5 and 6 have only a TM value at approximately 79° C. The samples contains rotavirus nucleic acid.

One with ordinary skill in the art will recognize from the provided description, figures and examples, that modifications and changes can be made to the various embodiments of the invention without departing from the scope of the invention defined by the claims and their equivalents.

1. Method for amplifying and identifying at least one target comprising:
(a) providing a sample containing at least one target,
(b) mixing at least one target with
(i) at least two primers, wherein more than one target can be amplified,
(ii) at least two sequence-specific probes,
wherein emitted light of the at least two sequence-specific probes is detected but cannot be distinguished,
(iii) an unspecific dye,
wherein emitted light of the unspecific dye is not detected in a detection channel which detects the emitted light of the sequence-specific probes in (ii),
(iv) oligonucleotides,
(v) a polymerase and optionally
(vi) buffer, MgCl2, amplification control and/or water,
(c) amplification of the target to produce amplified targets,
(d) melting curve analysis,
wherein the unspecific dye is used to distinguish the amplified targets during melting curve analysis.

2. Method of claim 1, wherein the amplification is a real time PCR.

3. Method of claim 1, wherein the amplification is a multiplex PCR with at least two pairs of primer and wherein the amplified targets are identified and distinguished in the melting curve analysis.

4. Method of claim 1, wherein the unspecific dye is a double strand DNA specific dye.

5. Method of claim 1, wherein the target is a nucleic acid including DNA or cDNA.

6. Method of claim 1, wherein the sample is selected from the group consisting of blood samples, urine samples, semen samples, lymphatic fluid samples, cerebrospinal fluid samples, amniotic fluid samples, biopsy samples, plant samples, needle aspiration biopsy samples, cancer samples, tumour samples, tissue samples, cell samples, cell lysate samples, crude cell lysate samples, forensic samples, archeological samples, infection samples, nosocomial infection samples, environmental samples, soil samples, water samples, plant leaf samples, pollen samples, seed samples, food samples and combinations thereof.

7. Method of claim 1, wherein the sequence-specific probed is/are selected from the group comprising TaqMan-probes, molecular beacons, scorpions, biprobes and hybridization probes.

8. Method of claim 1, wherein the unspecific dye is released during the melting curve analysis.

9. The method of claim 1, further comprising differentiation of amplified targets and/or unspecific products.

10. The method of claim 1, further comprising detection of bacteria, viruses, fungi, parasites, cancer, mutations and/or animal products.

11. The method of claim 1, further comprising diagnosis of diseases, GMO-screening, detection of pathogens or food quality testing.

12. Kit comprising
an unspecific dye,
at least two sequence-specific probes,
oligonucleotides,
a polymerase and optionally
buffer, MgCl2, an amplification control and/or water.

13. The kit of claim 12 additionally comprising at least two primers.

14. The method of claim 4, wherein the double strand DNA specific dye is ethidium bromide, GelRed and/or Sytox Orange.

15. The method of claim 9, wherein the amplified targets and/or unspecific products are primer dimers.

16. The kit of claim 12, wherein the unspecific dye is ethidium bromide, Gel Red and/or Sytox Orange.


SEQUENCE LISTING (15 sequences)

SEQ ID NO: 1 - DNA, 16 bp, Artificial Sequence
  Primer 35S Promotor forward
atggacccccacccac

SEQ ID NO: 2 - DNA, 23 bp, Artificial Sequence
  Primer 35S Promotor reverse
agatatcacatcaatccacttgc

SEQ ID NO: 3 - DNA, 20 bp, Artificial Sequence
  Probe 35S Promotor
gaagacgttccaaccacgtc

SEQ ID NO: 4 - DNA, 26 bp, Artificial Sequence
  Primer FMV Promotor forward
aagacatccaccgaagacttaaagtt

SEQ ID NO: 5 - DNA, 23 bp, Artificial Sequence
  Primer FMV Promotor reverse
tcgtgcaccattccttttttgtc

SEQ ID NO: 6 - DNA, 19 bp, Artificial Sequence
  Probe FMV Promotor
tggtccccacaagccagct

SEQ ID NO: 7 - DNA, 23 bp, Artificial Sequence
  Primer animal all forward
cacgaagcaggatctaataaccc

SEQ ID NO: 8 - DNA, 18 bp, Artificial Sequence
  Primer animal all reverse
ggggtagttgtctgggtc

SEQ ID NO: 9 - DNA, 22 bp, Artificial Sequence
  Probe farm poultry
tagccctattctcacctaacct

SEQ ID NO: 10 - DNA, 22 bp, Artificial Sequence
  Primer adenovirus forward
ccagtggtcttacatgcacatc

SEQ ID NO: 11 - DNA, 20 bp, Artificial Sequence
  Primer adenovirus reverse
acggtggggtttctaaactt

SEQ ID NO: 12 - DNA, 18 bp, Artificial Sequence
  Probe adenovirus
tctggtgcagtttgcccg

SEQ ID NO: 13 - DNA, 20 bp, Artificial Sequence
  Primer rotavirus forward
accatctacacatgaccctc

SEQ ID NO: 14 - DNA, 16 bp, Artificial Sequence
  Primer rotavirus reverse
ggtcacataacgcccc

SEQ ID NO: 15 - DNA, 25 bp, Artificial Sequence
  Probe rotavirus
cacaatagttaaaagctaacactgt